(19) United States
(12) Patent Application Publication
(10) Pub. No.: US 2025/0278447 A1
(43) Pub. Date: Sep. 4, 2025

(54) SYSTEMS AND METHODS FOR TRACKING RECEIPT OF A GIFT

(71) Applicants: Allen Borza, Lake Worth, FL (US); Eric Paul Ciccotelli, Chuluota, FL (US)

(72) Inventors: Allen Borza, Lake Worth, FL (US); Eric Paul Ciccotelli, Chuluota, FL (US)

(21) Appl. No.: 19/213,285

(22) Filed: May 20, 2025

Related U.S. Application Data
(63) Continuation-in-part of application No. 17/938,071, filed on Oct. 5, 2022, now Pat. No. 12,307,470.
(60) Provisional application No. 63/252,368, filed on Oct. 5, 2021.

(51) Int. Cl. G06F 16/955; H04L 51/224

(52) U.S. Cl. CPC G06F 16/955; H04L 51/224

(57) ABSTRACT

A method for tracking receipt of a gift includes creating an online message, generating a link associated with a landing page, a reveal code to unlock the online message at the landing page. A sender creates an off-line gift and sends the gift, a link to the landing page, and the reveal code to one or more recipients, either together or in various combinations. When a recipient follows the link and the reveal code is entered, the online message is displayed. The message may include the identity of the sender. The online message detects when recipients land on the page and collects data on the one or more recipients. This information, and or other information maybe in included in a read receipt delivered to the sender.

### BACKGROUND OF THE INVENTION

### Field of the Invention

The present invention relates to a method for tracking receipt of a gift. More particularly, the invention relates to an improved method of gift-giving that facilitates acquisition of online data and analysis.

### Description of the Related Art

Corporate gifting has become a major industry. It is commonplace for companies to send out cards and/or gifts to customers, vendors, and associates within the industry, and is often used as a marketing technique. Companies will send gifts not only as tokens of appreciation and gratitude to customers but will also send free gifts to prospective customers in the hope of attracting more business.

Unfortunately, it is difficult for companies to evaluate the effectiveness of such gift-giving. Often these gifts are sent to a recipient's business address. However, the gift might never be seen by the intended recipient due to oversight by a receptionist, assistant, or secretary, to whom the gift is often delivered by the postal worker. Moreover, once in the hands of the desired recipient, it may be reviewed upon opening and quickly forgotten about. This is especially true around holidays when companies and employees receive many gifts from many sources. Furthermore, a gift's sender has no way of knowing whether the recipient became aware of who the sender was, nor can they guarantee that the recipient will ever visit the sender's website. Thus, there is no direct way to evaluating the effectiveness of attracting a recipient's attention, and ultimately their business, by sending them a physical gift. In addition, receiving a gift and/or card does not directly generate any interaction between the sender and recipient, or with the sender's website, social media page, phone number or other means of contact. There is thus little chance that the sender will ever be able to glean any real data for evaluating the efficacy of gift-giving as a marketing tool.

One solution is to send a gift in an email that allows the receiver to redeem a gift card. This would allow the sender to track when the recipients clicks on the link or otherwise obtains their gift. Additionally, the sender would be able to evaluate which gifts are responded to the fastest, most likely to be used and obtain various tracking information, such as the email and IP address, of the recipients. Unfortunately, gifts sent via email have their own problems. Such messages are often discarded as spam and are easily overlooked. Such gifts are also usually in the form of a gift card or other relatively impersonal items and are therefore less likely to make an impact. In addition, a gift provided electronically is easier to dismiss and less memorable than a physical card or package received via snail mail. Nonelectronic, off-line gifts tend to provide the most distinct impression and receive more attention than email gifts.

The above-described deficiencies of today's systems are merely intended to provide an overview of some of the problems of conventional systems and are not intended to be exhaustive. Other problems with the state of the art and corresponding benefits of some of the various non-limiting embodiments may become further apparent upon review of the following detailed description.

It is therefore an object of the present invention to provide a means for generating marketing data including online tracking data directly associated with an off-line gift. From a corporate perspective, the principles of the invention provide the ability to improve the gift-giving experience with a multimedia online message that provides response data (replies, opens, actions and behavior). From a personal perspective, the principles of the invention provide the ability to improve the gift-giving experience PLUS customized surprise pages.

In view of the foregoing, it is desirable to provide a physical gift that allows a sender to obtain tracking data for marketing analysis.

### BRIEF SUMMARY OF THE INVENTION

Disclosed is a method for tracking receipt of a gift that includes the steps of identifying one or more recipients, assigning at least one message to each of the recipients, sending an off-line gift to each of the one or more recipients, sending a link to a landing page to each of the one or more recipients, sending a reveal code to each of the one or more recipients and, upon one of the one or more recipients entering the reveal code on the landing page, displaying the at least one message assigned to that recipient.

Data relating to a recipient's interactions with the message may also be collected. In some embodiments, the message identifies the sender. The message may include at least one interaction module which allows the recipient to perform a task, such as sending the sender a reciprocal gift, sending the sender a thank you note, making a donation to a third party, and selecting the off-line gift.

In some embodiments, both the reveal code and the link to the landing page are attached to the off-line gift. The reveal code and link to the landing page may also be sent as a gift receipt from a third party from which the off-line gift was sent.

In some embodiments, the reveal code and link may be provided via an email, an SMS text message, or a notification from a cellphone software application. They may take the form of an alphanumeric code, a scannable code, a QR code, a bar code, an answer to a challenge question, a biometric reading of the recipient, a geographic location of the recipient.

In some embodiments, the data collected may include an IP address from which the link is accessed, a number of times the link has been accessed. The data may also optionally be associated with the recipients. The messages may be assigned to recipients by creating one or more recipient groups, and assigning one of the at least one messages to each of the recipient groups. The recipient groups may be assigned according to the geographic locations of the recipients, or may be assigned randomly.

In some embodiments, the data collected may include the amount of time each of the recipients interact with each of the interaction modules, the date and time on which the one or more recipients interact with each of the interaction modules, and the number of times the one or more recipients interact with each of the interaction modules.

In other embodiments, the method for tracking receipt of a gift may include identifying one or more recipients, sending an off-line gift to each of the one or more recipients, sending a link to a landing page to each of the one or more recipients, sending a reveal code to each of the one or more recipients, and generating and displaying a message for the recipient when the recipient enters the reveal code on the landing page. The message may be generated based on one or more of that recipient's geographic location, type of electronic device used to access the landing page, a number of times that the reveal code has been entered, a date on which the reveal code is entered, a number of times that the reveal code has been entered by that recipient; a type of browser used by that recipient to access the landing page.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a flowchart of a method for tracking receipt of a gift in accordance with the principles of the invention;

FIG. 2 is a flowchart of an alternative embodiment of a method for tracking receipt of a gift in accordance with the principles of the invention;

FIG. 3 is a flowchart of an alternative embodiment of a method for tracking receipt of a gift in accordance with the principles of the invention;

FIG. 4 is a flowchart of an alternative embodiment of a method for tracking receipt of a gift in accordance with the principles of the invention;

FIG. 5 is a flowchart of an alternative embodiment of a method for tracking receipt of a gift in accordance with the principles of the invention;

FIG. 6 is a flowchart of another alternative embodiment of a method for tracking receipt of a gift in accordance with the principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Unless otherwise indicated, all numbers expressing quantities, dimensions, reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting.

Various embodiments of the disclosure could also include permutations of the various elements recited in the claims as if each dependent claim was a multiple dependent claim incorporating the limitations of each of the preceding dependent claims as well as the independent claims. That is, the combinations of the various components of the invention are not limited to those combinations expressly described. Unless expressly stated otherwise, components described in one embodiment may be interchanged with components of the same name found in other embodiments. Components found in one embodiment may similarly be added to and/or combined with other embodiments. Such permutations are expressly within the scope of this disclosure.

Disclosed is a method for tracking receipt of a gift comprising creating an online message accessed through a landing page. The message may include one or more interaction modules. A sender may obtain a link to a landing page, managed by the sender itself or optionally by a third party operating a platform for facilitating the systems and methods of the invention. A sender may also obtain a reveal code that may be inserted onto the landing page in order to generate a message. The sender may generate a new reveal code, use an existing one, or purchase a reveal code from a third-party managing a platform which facilitates the principles of the invention. The sender can then send an off-line gift, the reveal code and the link to the landing page to one or more recipients. One or all of these items may be sent anonymously, and they may be sent together or separately, or in different combinations.

When the recipient follows the link to the landing page and enters the reveal code, the message selected by the sender is displayed. The online landing page and/or message detects when the recipient lands on the page and collects data on the recipient. Those skilled in the art will appreciate that landing pages themselves as well as objects displayed on an Internet page through a browser are capable of tracking many types of data, including the location of the electronic device being used to access it, the amount of time spent at a particular landing page or viewing a message, the amount of time a recipient spends engaged with an interaction module within the message, the type of browser used to access the landing page and message, the upload and download speed of the electronic device engaging the landing page or message, and the like. Those skilled in the art will appreciate that there is a wide variety of data that may be collected when a person such as a recipients interacts with a landing page, message and interaction modules of the invention. The fact that the recipient can access the message using the reveal code establishes that the reveal code was received by the person operating the electronic device. By using various interacting modules, the sender can gauge how interested the recipient is in the message and/or the functions of the various interaction modules. Data regarding a recipient's interaction with the landing page, message and/or interaction modules can be collected, organized and provided to the sender.

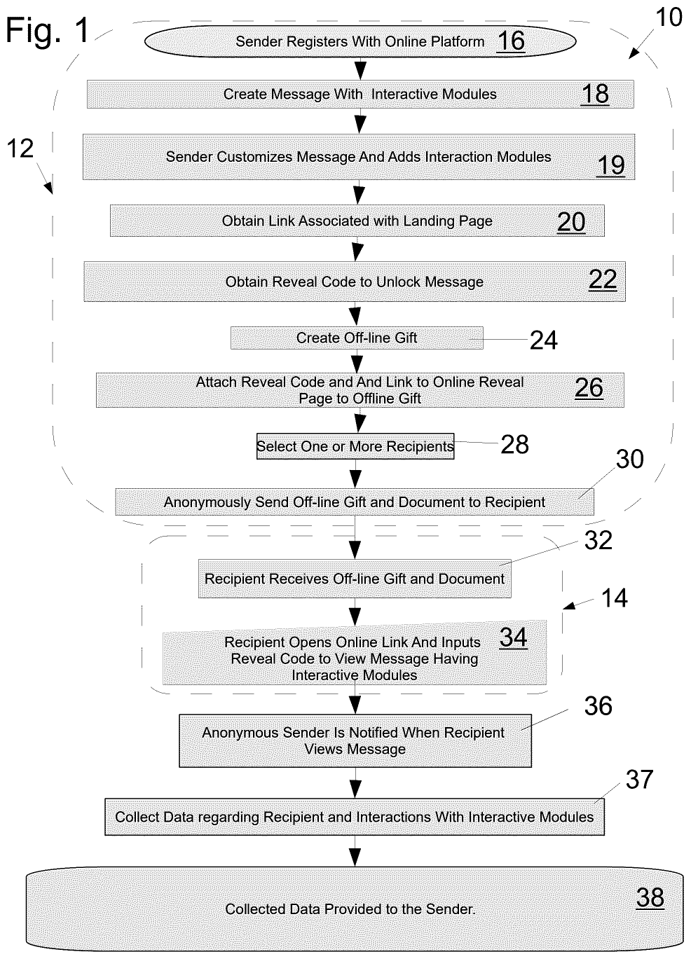

FIG. 1 displays a flowchart of a method for tracking receipt of a gift 10, in accordance with the principles of the invention. In this embodiment, an online platform facilitates the systems and methods of the invention. The receipt of a gift 10 is tracked by a series of steps performed by the sender 12, followed by a series of steps completed by the recipient 14. First, a sender registers with the online platform 16. This is done by creating an account and purchasing a single message or multiple messages through the platform. Optionally, a single reveal code or multiple reveal codes can be purchased at a retail store and activated at the cash register, as per retail gift cards, or activated by the sender logging into or creating its account on a third-party platform. Once an account has been made and a message or multiple messages have been created or purchased, the sender has access to a dashboard to track, create, and edit each message associated with its account. The sender can then identify one or more recipients and assign one or more messages and reveal codes to each of the recipients. Optionally, the sender may organize the one or more recipients by dividing them into specific groups of recipients, based on the recipients' geographic location, gender, age, or other parameters. Each of the groups of recipients may be assigned one or more messages.

The sender then uses the dashboard to generate and customize an online message with integrated interactive modules 18. In this embodiment, the online message is used to reveal the sender's identity and includes one or more optional interactive modules to allow the sender to collect data on the recipient. The online message may be customized for a particular gift, particular recipient, or particular category of gift or recipient. Furthermore, the sender may upload a variety of objects to the online message from their computer or mobile device 19, including audio files, gifs, videos, interactive displays, or the like. These interactive modules can include components, such as questionnaires, fillable forms, raffles, games, video links, links to the sender's website or other websites. Optionally, the interactive modules inside the online message could be utilized as party invitations, to launch or relaunch a campaign, or to redirect recipients to a live video, such as a proposal, zoom meeting, conference, or the like. Furthermore, the online message may be hosted by the online platform or may optionally be a webpage of a separate website owned or managed by the sender or third party. Finally, the online message may serve as a small marketplace for various products sold by a company, or sponsored ads.

Once the online message has been fully customized, the link to the online message will be generated 20 for the sender to provide to the recipient. The link may be a simple internet link that can be typed into a phone or computer internet browser. The sender must also create a reveal code to unlock online message 22. The reveal code may be automatically generated by the platform or customized by the sender. The reveal code can be a PIN, a six-digit code, an alphanumeric string, a QR code, a barcode, a challenge question for which the recipient must enter a correct answer, or the like. This code help to prevent a sender's gift from being opened or redeemed by an unwanted party, and insurers that the correct recipient is the viewer of the message. Optionally, the reveal code may also be a geographic location from which the landing page must be accessed in order for the message to be opened, a type of biometric measurement a recipients must enter on the landing page.

Next, the sender selects an off-line gift 24, the link to the landing page used to enter the reveal code, and the reveal code itself which unlocks and/or displays the online message 26 associated with that reveal code. The offline gift may be cookies, chocolate, other prepared and packed food, a beverage, gift card, flowers, a sentimental object, personalized present, or the like. The gift can also be something more elaborate, such as billboard, a personally delivered message such as a singing telegram, or any other object, performance, or display. The gift may also optionally be something as simple as a gift card or letter. The landing page can be a page created by the sender on its own website or another, or may optionally be a landing page belonging to a third-party which operates the platform the sender is using to perform the systems and methods of the invention. The link to the landing page may be simply the URL of the landing page, or may be translated into a QR code, a barcode, and input code for a phone app, an NFC signal or any other object that may be used to access a landing page. The link to the landing page and/or the reveal code may be attached directly onto the online gift or may be Incorporated into a document such as a car door postcard sent with the off-line gift.

Once an offline gift has been created 24, the sender selects one or more recipients 28 to which the offline gift(s) is sent. The recipient may be an individual, a company, any other type of entity, or a group of entities. After selecting the recipient(s), the offline gift(s) the link to the landing page and reveal code are sent to the recipient(s) 30 by the sender or by the third-party platform being used by the center. These three items may be sent together, individually or in combinations. For example, the landing page and/or reveal code may be attached to the off-line gift by a label or packaging. Optionally, the reveal code and/or landing page may be sent via email, SMS text message or as a notification from a phone application once a sender has received confirmation that the off-line package was delivered. The link and reveal code may be included in an email gift receipt sent to the recipient. For example, the off-line gift may be sent by Amazon® or a similar online retail platform, which then sends a gift receipt email to the recipient that includes the link and the reveal code. Optionally, the link and/or reveal code may be sent with a message indicating that the reveal code may only be used one time. This may reduce the possibility that a receptionist at an organization, rather than the intended recipient, will access the message using the provided reveal code.

The recipient receives the off-line gift, the link and the reveal code (which may be incorporated into a single document) 32 from the sender. The sender may do this anonymously such that the sender's name does not appear on anything sent to the recipient. When the recipient follows the link and enters the reveal code, the identity of the anonymous sender is revealed and the interactive modules are unlocked, or otherwise become engageable by the recipient, 34. The sender can also customize the online

page to include a countdown once the recipient has entered the reveal code to add further suspense and excitement. This countdown can be customized with confetti, glitter, or further animation. Additionally, the message can be customized to include one or more interaction modules which may initiate media, such as music or video, upon entering the reveal code and may also optionally redirect the recipient to a new webpage. By sending these items anonymously, it piques the recipient's interest, thus making the recipient more likely to engage the link and enter the reveal codes to learn who sent the gift. Typical promotional and marketing postcards and emails in general provide little incentive for a recipient to confirm receipt or to follow up with the sender. By adding mystery into the interaction with the recipient, the sender is much more likely to elicit a response from the recipient. This is especially true when an anonymous sender has sent a gift before the recipient has visited a website or otherwise engaged with the sender. The gift, link and reveal code may optionally be sent non-anonymously, identifying the sender.

When the recipient views the online message 36, data regarding the recipient and its interactions with the landing page and method are collected 37. The sender is provided this information 38 through a dashboard on a third-party platform or otherwise. This allows a sender to determine which interactive modules are most popular with the recipients in order to prepare more effective messages in the future. The data recorded may include the date, time, and IP address each time the online message is accessed. The sender can associate this data with the recipient based on the reveal code used. This allows the sender to acquire and/or confirm a particular physical address for a particular recipient or group of recipients. The sender can also use the IP address or other information to track interactions between the sender's website and the recipient. Additionally, the online message could be programmed to track the duration of time spent on the page by the recipient, the number of visits by the recipient to the online message, the browser used, the type of device, the location of the device, UTM parameters, and the types of interactions with the online message. Finally, the online message can be programmed to notify the sender of delivery confirmation, when and how often the page is opened, and if the recipient failed to land on the online message. This can all be displayed on the sender's dashboard.

Because a recipient does not know who sent the message, the recipient's curiosity greatly increases the likelihood that the link will be followed to identify the sender. This increases the recipient's interaction with the gift, engagement with the web platform, and forms a stronger association and memory with the sender. Furthermore, as opposed to traditional styles of offline gift giving, the probability and duration of interaction between the recipient and the message and/or the messages interaction modules is greatly increased by this process. This provides companies with valuable marketing data and allows them to track the effectiveness of their gift giving. For example, the message could include a Mad Libs® style fill in the blank game that invites the recipient to select words to be inserted into a text to create a humorous story. The words selected by the recipient can provide useful data for marketing analytics. Analytic tools can also be used to measure how long the recipient views and interacts with various regions of the message. Such analysis provides valuable feedback to the sender regarding the effectiveness of targeted marketing and target consumers.

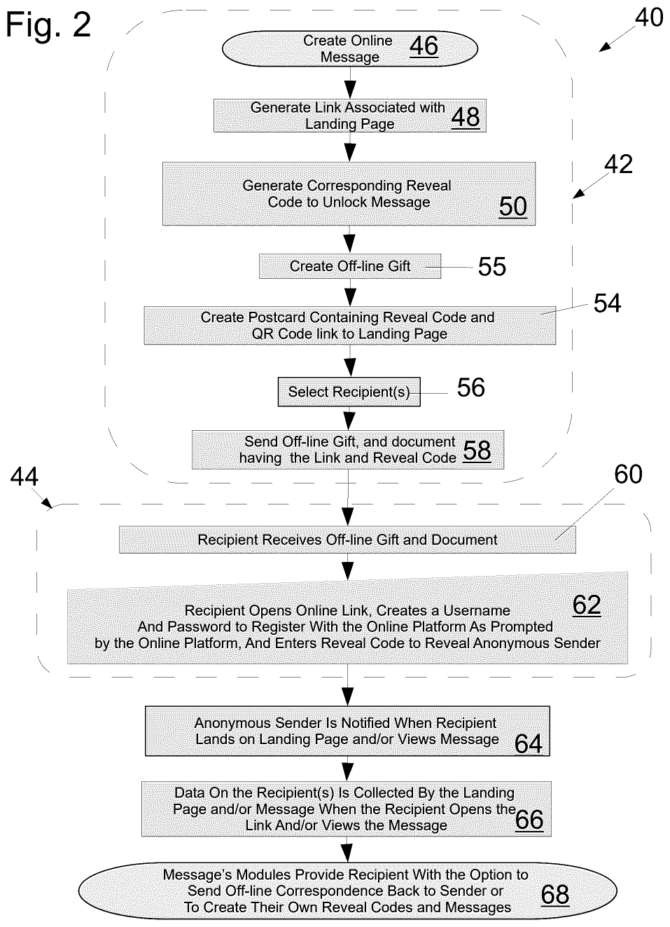

FIG. 2 displays a flowchart of an alternative embodiment of a method for tracking receipt of a gift 40, in accordance with the principles of the invention. In this embodiment, an online platform facilitates the systems and methods of the invention. The receipt of a gift 40 is tracked by a series of steps performed by the sender 42, followed by a series of steps completed by the recipient 44. First, a sender uses the platform to generate and customize an online message 46. In this embodiment, the online message is optionally used to reveal the sender's identity. Once the online message has been fully customized, the link to the online message will be generated 48 for the sender to provide to the recipient. In this embodiment, the link is encoded as a QR code or other scannable code. This scannable code may optionally also bypass authentication or confirm authentication. The sender must also create a reveal code to unlock online message 50.

Next, the sender selects an off-line gift 55 and creates a postcard or other document such as a letter, email or text message, containing the QR code for the online message and the reveal code 54. The sender then selects a recipient 56 and anonymously mails the offline gift and sends the document 58. The recipient then receives the off-line gift and document 60 from the anonymous sender by snail mail or delivery. When the recipient scans the QR code on their phone, the online platform directs the recipient to create a username and password to register an account with the online platform. Once they have registered, the recipient can enter the reveal code 62 to reveal the identity of the anonymous sender.

In this embodiment, the sender is notified when the recipient lands on the online message 64 and collects valuable tracking and marketing data on the recipient 66. Furthermore, the message can be customized to allow the recipient to send an online or off-line message, or other response to the sender. This feature can allow the sender to track the recipient's interest level in the product and the company based on their likelihood of the recipient to thank the sender for the off-line gift. In this embodiment, the online message provides the recipient with the option to send receipt of a gift back to the sender or to generate an online message 68. The receipt of a gift can be a thank you card, postcard, gift, or the like. Furthermore, by directing the recipient to create a username and password with the online platform, the recipient is automatically registered with the online platform. This allows the recipient to create their own online message. Thus, providing them with the ability to anonymously send receipt of a gift back to the sender, or to their customers, associates, friends, or family, upon purchasing a customizable message through their account.

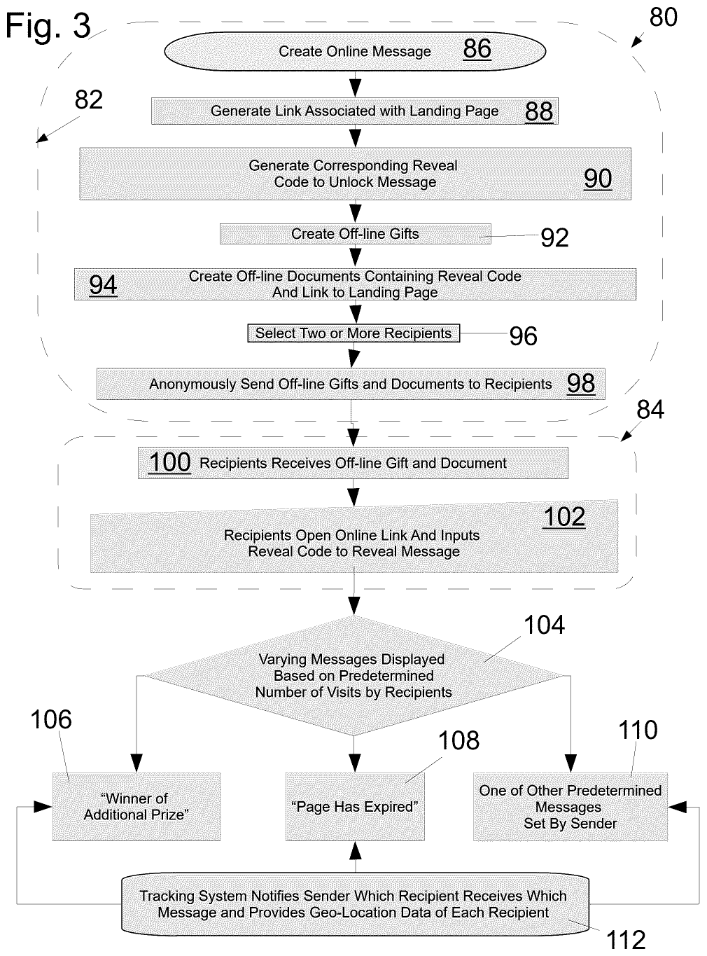

FIG. 3 displays a flowchart of an alternative embodiment of a method for tracking receipt of a gift 80, in accordance with the principles of the invention. In this embodiment, an online platform facilitates the systems and methods of the invention. The receipt of a gift is tracked by a series of steps performed by the sender 82, followed by a series of steps completed by the recipient 84. First, a sender uses the platform to generate and customize an online message 86. In this embodiment, a reveal code is used to unlock the online message. Once the online message has been fully customized, the link to the online message will be generated 88 for the sender to provide to the recipient. The sender must also create a reveal code to unlock the online message 90.

Next, the sender creates multiple off-line gifts 92 and documents containing the link for the landing page and the reveal code 94. The sender then selects two or more recipients 96 and anonymously mails the offline gifts and documents 98. The multiple recipients then receive the off-line gifts and documents 100 from the anonymous sender. When the multiple recipients open the link and enters the reveal code 62, the message on the online message is revealed.

In this embodiment, there are varying messages, which have been customized by the sender, set to appear at random or based on a predetermined number of visits by the recipients 104. The sender can use the same message, link, and reveal code for multiple recipients, or may send a unique message to each of many recipients for the same webpage. In this embodiment, the message displayed can be selected from messages that state “Winner of Additional Prize” 106, “Page Has Expired” 107, or a standard message by the sender 110. These messages can be set to be displayed at a predetermined number of visits or may be programmed to appear at random. Furthermore, the online message contains a tracking system which notifies sender when each message appears and links each recipient with the message they received 112. The tracking system also provides the sender with the geo-location data for each recipient.

Optionally, the sender may create separate online messages for each recipient or for groups of recipients. Additionally, in case of a typographical error or undesired response from the recipients, the sender can change the online message so that after a certain date, anyone using the link and/or reveal code will see the updated version. The online message may also be programmed to change after each time it is viewed. The message can also be pre-programmed to provide different experiences to different recipients based upon the time between the receipt of a gift or message and the time when the message is accessed. Finally, the online message can be programmed to be publicly visible without the need for the reveal code, after a predetermined number of visits or set amount of time.

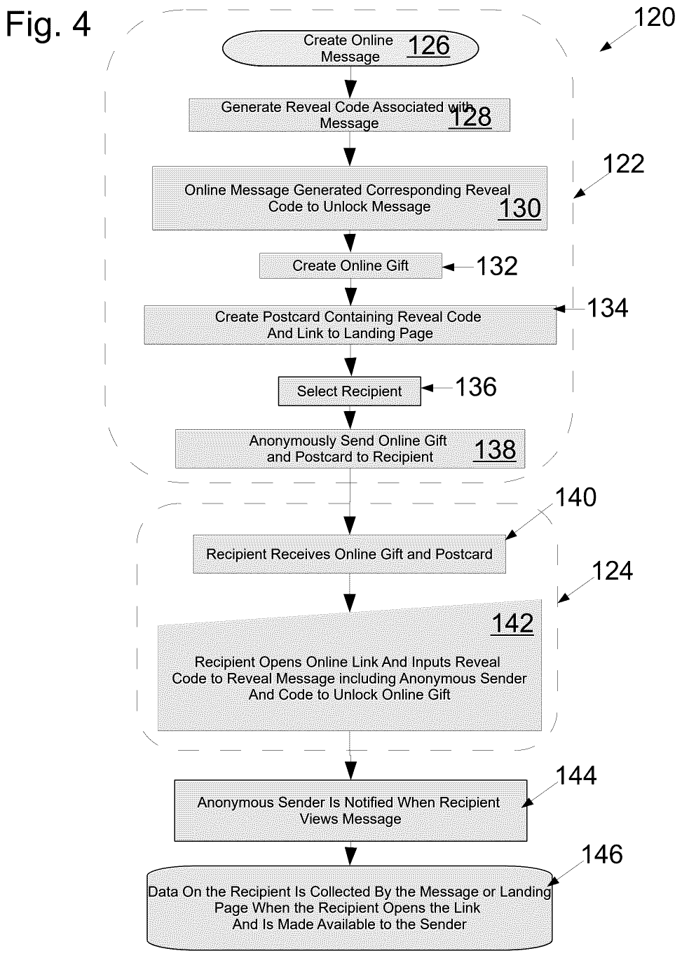

FIG. 4 displays a flowchart of an alternative embodiment of a method for tracking receipt of a gift 120, in accordance with the principles of the invention. In this embodiment, an online platform facilitates the systems and methods of the invention. The receipt of a gift 120 is tracked by a series of steps performed by the sender 122, followed by a series of steps completed by the recipient 124. First, a sender uses the platform to generate and customize an online message 126. In this embodiment, the reveal code is used to reveal a message. Once the online message has been customized, the link to the online message will be generated 128 for the sender can provide the link to the recipient. A reveal code is also generated by the online message to be entered when the link is clicked and to unlock online message 134.

Next, the sender selects and sends an online gift and creates a postcard containing the link for the online message and the reveal code 138. In this embodiment, the online gift is sent electronically via email, SMS, through social media, or other means of electronic transfer, and the off-line postcard is sent to the recipients address via snail mail or deliver. The recipient then receives the online gift and document 140. When the recipient opens the online link on their phone or computer and enters the reveal code 142, the identity of the sender is revealed. In this embodiment, the online message is further customized to reveal a code to unlock an online gift. This prevents the online gift from being opened or used by an unwanted party. The online message is also customized to notify the anonymous sender when the recipient lands on the online message 144 and collects valuable tracking and marketing data on the recipient 146. The sender may also receive updates when a gift is sent and when the recipient selects one or more gifts from a list of possible gifts. The message may include one or more interactive modules. One of the interactive modules may optionally allow the recipient to select one or more gifts depending upon a number of redemption points obtained by the recipient.

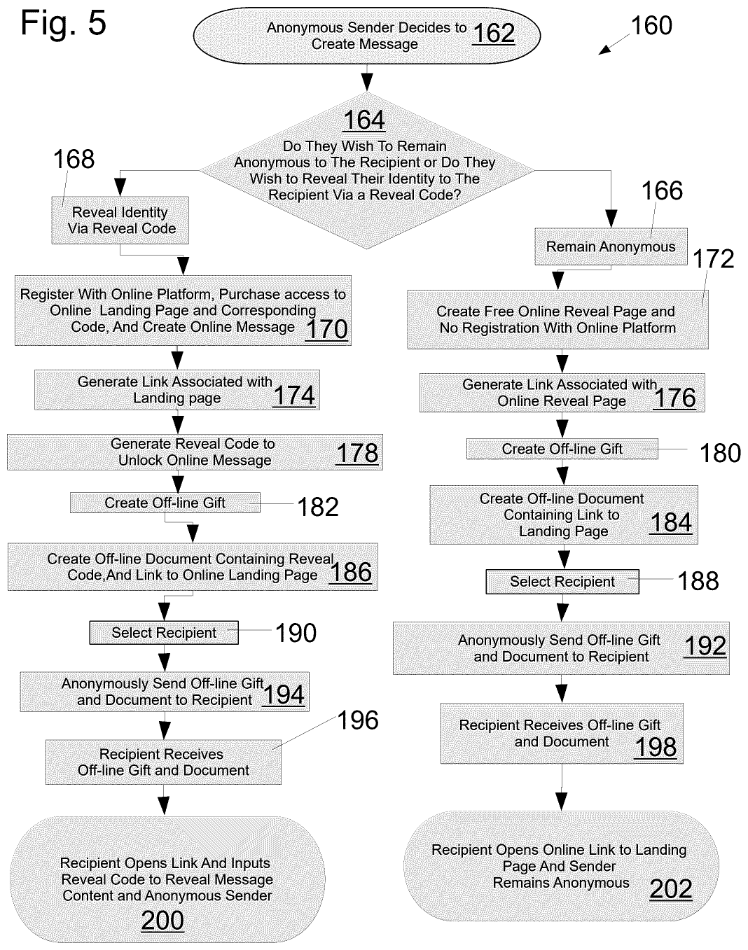

FIG. 5 displays a flowchart of an alternative embodiment of a method for tracking receipt of a gift 160, in accordance with the principles of the invention. In this embodiment, the sender has the option to choose whether to remain anonymous to the recipient, or to purchase a reveal code to reveal their identity through the online platform 164. First, an anonymous sender decides to use the online platform to generate and customize an online message 162. If the sender wishes to reveal their identity via a reveal code 168, the sender must register with the online platform and purchase an online message and reveal code 170. The sender would then generate a link 174 and a reveal code 178 and create a gift 182 and an off-line document containing the link and reveal code 184, as in other embodiments. The recipient would then be selected 190 and anonymously sent the gift and document 194. Once the recipient receives the off-line gift and document 196, they able to open the online message through the link provided and enter the reveal code to reveal the anonymous sender and the online message content 200. If the sender optionally wished to remain anonymous 166, they create a free online message and are not required to register with the online platform 172. The sender would then generate a link 176, create a gift 180 and an off-line document containing the link 184, select a recipient 188, and anonymously send the gift and document to the recipient 192. The recipient then receives the off-line gift and document 198 and is able to open the online message through the link provided 202. In another embodiment, if the sender initially chose to bypass creating an account and purchasing a reveal code, no message may be displayed by the online message and the sender will remain anonymous.

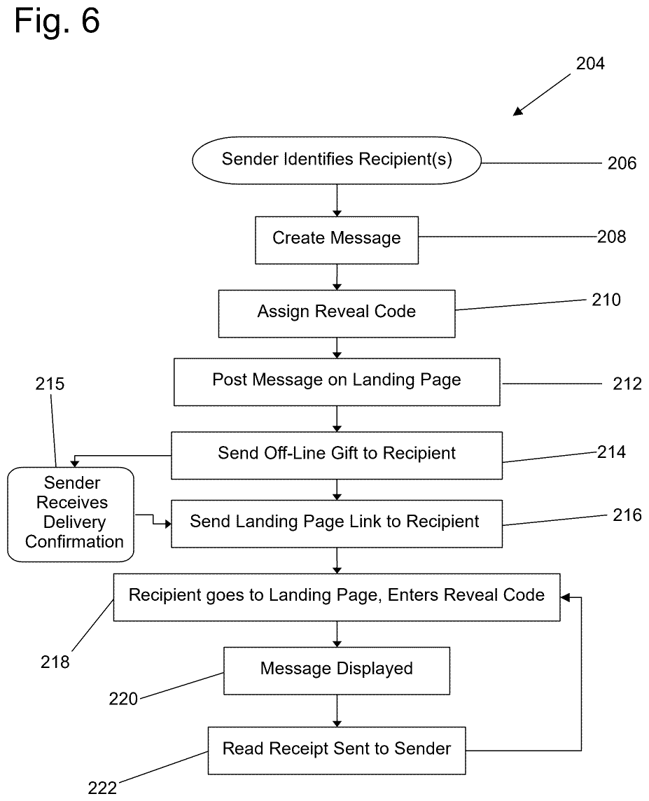

FIG. 6 shows another alternative embodiment of tracking receipt of an off-line gift 204 in accordance with the principles of the invention. The method begins with the sender identifying one or more recipients 206. Recipients may be persons known to the sender, or unknown persons such as for example prospective customers, leads and/or past customers. Next, the sender creates a message 208 for the identified recipient(s). The message may be created by the sender directly and may be anonymous or may identify the sender. Optionally, the message may be created using one or more message components provided by an online platform that assist cinders in generating messages. These messages, like the messages described above, may include interactive modules, animation, video, audio messages and combinations thereof.

The sender then assigns a reveal code 210 to the message. A reveal code is a data element assigned to a recipient, or group of recipients, that, when entered or validated, enables access to a landing page associated with a gift. The reveal code may be manually entered by the recipient or authenticated automatically through system processes. Examples of reveal codes include, but are not limited to a numeric or alphanumeric passcode, a scratch-off PIN, a recipient's phone number, email address, or birth date, a password associated with a pre-existing user account, a session-based token, a biometric signature or device ID, a scannable QR code that contains an embedded code value, a proximity-triggered authentication using NFC, RFID, Bluetooth, or device sensor input. The reveal code may be randomly generated by the sender, by a third-party platform being used to generate the message, or any other means. The reveal code may optionally be data previously provided to the sender by the recipient. For example, if the recipient is a current or previous customer of the sender, the sender may have a variety of information regarding the recipients, including name, address, email, phone number, preferences, demographic information, information regarding recipients relatives, and the like. If the sender operates a website or software application used by the recipient, the sender may also have information such as a username and password. The sender may simply choose an existing user's password as the reveal code when that particular user is the recipient of the message. Optionally, the reveal code may simply be the recipients phone number or city of residence.

The reveal code may also be a device recognition signal. A device recognition signal is to any signal, token, identifier, or transmission originating from a computing device that can be used to authenticate, identify, or validate the recipient's access to the landing page. It can include but is not limited to a device UUID (Universal Unique Identifier), a MAC address, device fingerprinting data, a trusted device token or cookie, a operating system-level device ID, a digital certificate stored on the device, Bluetooth or wi-fi handshake data, or a browser fingerprint or cryptographic hash generated from device traits.

This term allows coverage of any automated, semi-automated, or passive signal generated or transmitted from the device that is recognized by the platform to authenticate or identify the user.

A system may enable authentication of the reveal code through direct user input or through passive methods, including by passing the reveal code in an embedded, encrypted, or tokenized format for automatic validation by the system. Authentication may occur server-side, client-side, or through coordinated platform integration, and may be triggered by scanning, tapping, geolocation, account recognition, or secure session handling.

Once the message is created in step 208, a landing page is generated for displaying the message in step 212. A landing page may be a digital interface, destination, or environment that is capable of displaying a digital message or triggering a related experience upon recipient access. The landing page may include, but is not limited to: a standard webpage accessed through an internet browser, a page or view rendered within a native or web-based mobile application, an in-app module or embeddedframe, a virtual reality (VR) interface or environment, an augmented reality (AR) overlay, holographic display, or spatial computing environment, a smart display, voice assistant interface, a mixed-reality projection, a token-gated, platform-hosted, or session-specific experience dynamically rendered based on access parameters. The landing page may be static or dynamic, and may include features such as personalized content, animations, interactive elements, multimedia, or message delivery controls. It may also perform identity verification, data logging, or conditional display logic depending on recipient input, device type, location, timing, or prior interaction history.

The landing page may be accessible through an Internet browser or optionally through a software application. Assigning the reveal code 210 and posting the message on a landing page 212 may be done in the order shown in FIG. 6, may be performed simultaneously, or in reverse of the order shown. Once the sender has selected a reveal code 210 and posted the message on the landing page 212, and off-line gift is sent to the recipient 214. The gift may be sent by a third-party, for example the same entity that operates a platform used by the sender to generate the message. The sender may also optionally send the off-line gift personally or use another entity to send the off-line gift.

The sender also sends the landing page link to the recipient 216. The link to the landing page may be any mechanism, data object, signal, or reference that directs, enables, or facilitates a recipient's access to a digital message, landing page, or immersive experience associated with a gift. A link may take the form of a uniform resource locator (URL), a QR code or other machine-readable code that encodes a URL or identifier, a clickable hyperlink or app-deep link, an embedded redirect or tokenized access reference, a scannable code on packaging or merchandise, a system-generated token or session key delivered via a third-party platform, a push notification, SMS, email, or in-app message that triggers access, a wireless signal-based reference such as NFC, RFID, or Bluetooth Low Energy (BLE), or any digital or physical mechanism that, when activated, initiates access to a digital environment or triggers message display.

The link may be sent with the online gift, mailed separately, or sent to the recipient electronically such as for example using SMS, a direct messaging, a messaging system within a software application, email, push notification, or the like. When the link to the landing page is not sent with the off-line gift so that steps 214 and 216 are performed simultaneously, the link may optionally be sent once the sender is notified that the recipient has received the gift 215. For example, the sender may use a courier service to deliver the gift. Many courier services allow senders to track a package and also provide delivery confirmations to a sender. In the optional step 215, when the sender receives a delivery confirmation, that triggers the sending of the landing page link to the recipients. This process may optionally be automated so that a processor automatically electronically sends the link to the landing page to the recipient as soon as the sender receives delivery confirmation from the courier service.

The link may also optionally be triggered by a device-based sensor input. For example, a recipient may be required to interact with an electronic device to activate the link so that the recipient is able to view the landing page. For example, an accelerometer may be used to detect shaking or tapping the device. A gyroscope may be used to detect motion or orientation. A microphone may be detecting sound commands or specific audio tones. A camera may be used to detect visual input such as scanning an image, light flash, or gesture recognition. An ambient light sensor may be used to detect changes in lighting used to activate an interface. A biometric sensor may be used to detect a fingerprint or facial recognition as a trigger. A touchscreen may be used to detect a swipe pattern or tap sequence. A thermal sensor may be used to measure contact or proximity to human skin. A proximity sensor may be used to detect when the device is brought near another object.

The gift may be a tangible or physical item delivered to a recipient in association with a digital message or experience. The gift may be provided by an individual, organization, manufacturer, retailer, advertiser, or automated system and is not limited to items given for personal, sentimental, or altruistic reasons. A gift may include, but is not limited to, a consumer product purchased online or in-store; a promotional item, such as a giveaway or free product distributed as part of a marketing campaign or incentive program; a sample or subscription box item; branded merchandise, including physical goods bearing a company's logo or brand identity that are sold, gifted, or included with purchases, whether or not part of a promotional effort; packaging material; a greeting card, direct mail piece, or physical token (e.g., sticker, collectible); a prize, reward, or loyalty program item, any physical medium capable of delivering, triggering, or referencing a related digital experience. The gift may be sent anonymously, by a known sender, or automatically generated by a platform or system.

In this embodiment, the reveal code may be provided to the recipient in one of several different ways. The reveal code could be combined with the link to the landing page. Using this option, the sender may generate a QR code, alphanumeric code, or similar form of data to the recipient. When the recipient scans the QR code, it automatically connects the recipient to the landing page and simultaneously automatically enters the reveal code. Alternatively, the message with the link to the landing page may include an identification of a reveal code already known to the recipient. For example, if the sender has selected a recipient's username and/or password as a reveal code, the message containing the link to the landing page may also instruct the recipient that the reveal code required on the landing page is the recipient's password used to log in to the sender's webpage or software application. Other information, such as the recipient's address, city or state of residence, birthdate or the like may similarly be used as a reveal code. Using this type of data allows the sender to confirm that the correct recipient receives the off-line gift. Optionally, the reveal code may be the same as that described in previous embodiment and may be provided to the recipients with the online gift, with the link to the landing page, or both.

Once a recipient has received the off-line gift, the landing page and reveal code, the recipient enters the reveal code on the landing page 218. As explained above, both link and reveal code may be combined into a single representation, such as a QR code or alphanumeric link. This causes the landing page to display the message 220. If the message includes an interactive module, the recipient's interactions with the interactive module may be recorded, along with the date and time when the message was accessed. The message may also include interactive media. Interactive media may include any form of digital content that allows the user to engage with or manipulate elements of the content in real time or based on user input, such as embedded polls or quizzes, tap-to-reveal elements, choose-your-own-path narratives, simulations, games, or augmented/virtual reality experiences, web-based widgets or interactive UI components, live-streamed events with real-time engagement. The message may also include a digital collectible, such as NFTs (non-fungible tokens) stored on a blockchain, non-blockchain digital certificates or tokens representing exclusivity, downloadable art, files, or digital goods that are personalized or serial-numbered, virtual items in a digital wallet or collection (e.g., game rewards, badges).

As explained above in regard to the previous embodiments, other information may also be recorded such as the geographic location from which the recipient access the landing page, the number of times the landing page is accessed, the IP or other address from which the landing page was accessed, the amount of time the message was displayed, and the like. This information may be provided in the read receipt sent to the sender in step 222. The read receipt is a notice to the sender and may take many forms, for example, a web-based dashboard notice, a system log entry, a downloadable report, and exportable report, and a physical read receipt.

Those skilled in the art will appreciate that the sender, and/or the entity that provides a platform forming the methods of the present invention, may use the data obtained for a variety of purposes. Data can be analyzed to determine which messages recipients are most likely to interact with, which messages are viewed most often, which off-line gifts result in a recipient interacting with a landing page, and the like. Those skilled in the art will also appreciate that this data can be analyzed using deep learning, i.e. artificial intelligence, to identify which types of gifts and modules are best suited for different types of recipients.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A method for tracking receipt of a gift comprising:
a sender identifying one or more recipients;
assigning a message for the one or more recipients;
assigning a reveal code for each message;
generating, by a processor, a landing page on which the message is displayed;
sending an off-line gift to each of the one or more recipients;
sending a link to the landing page to each of the one or more recipients;
upon one of the one or more recipients entering the reveal code on the landing page, the processor:
displays the message on the landing page;
records data relating to the recipient's access of the landing page; and,
sends a read receipt for the off-line gift to the sender, the read receipt for the off-line gift including the date and time on which the first message was viewed.

2. The method for tracking receipt of a gift of claim 1 wherein the read receipt comprises a notification selected from the group consisting of an email, a text message, a push notification, an in-application notification.

3. The method of tracking receipt of a gift of claim 2 wherein the landing page comprises an interface selected from the group consisting of a webpage accessible through an internet browser, an in-application page, virtual reality interface and an augmented reality interface.

4. The method of tracking receipt of a gift of claim 3 wherein the link to the landing page is selected from the group consisting of a scannable code, near-field communication signal, a radio frequency identification signal, a Bluetooth proximity signal, and a device-based sensor input.

5. The method of tracking receipt of a gift of claim 4 wherein the reveal code is selected from the group consisting of a platform-based authentication code, login credentials, a biometric signal, and a device recognition signal.

6. The method of tracking receipt of a gift of claim 5 wherein the data relating to the recipient's access of the landing page comprises is one or more data selected from the group consisting of the number of time the message has been viewed, the recipient's IP address, a geographic location, and a device identifier.

7. The method of tracking receipt of a gift of claim 6 wherein the message includes the identity of the sender.

8. The method of tracking receipt of a gift of claim 7 wherein the message is only displayed after the occurrence of a predefined condition selected from the group consisting of a delivery confirmation, a delivery status, a non-deliverable status, and a specific date and time.

9. The method of tracking receipt of a gift of claim 8 wherein the message comprises one or more elements selected from the group consisting of text, an image, an audio signal, a video, animation, interactive media, and a digital collectible.

10. The method of tracking receipt of a gift of claim 9 wherein reveal code comprises data previously provided by the recipient selected from the group consisting of a phone number, an email address, a birth date, a username, and a password associated with a pre-existing user profile.

11. The method of tracking receipt of a gift of claim 10 wherein the pre-existing user profile is a profile for an account not managed by the sender.

12. The method for tracking receipt of a gift of claim 11 wherein the link to the landing page and the reveal code are combined into a single QR code such that scanning the QR code automatically directs a recipient to the landing page and automatically enters the reveal code.

13. The method for tracking receipt of a gift of claim 12 further comprising:
providing the processor with an electronic delivery receipt when the off-line gift is delivered; and,
upon receiving the delivery receipt, the processor sending the link to the landing page by electronic means selected from the group consisting of SMS, email, a messaging application, and a push notification.

14. The method for tracking receipt of a gift of claim 13 wherein the landing page is accessed using a software application.

15. The method for tracking receipt of a gift of claim 14 wherein the reveal code comprises data previously provided by the recipient to the sender.

16. The method for tracking receipt of a gift of claim 15 wherein the reveal code comprises a password for a pre-existing user profile of the one or more recipients.

17. The method of tracking receipt of a gift of claim 16 wherein the link to the landing page is activated by a device-based sensor input.
